(19) United States
(12) Patent Application Publication
(10) Pub. No.: US 2010/0018404 A1
(43) Pub. Date: Jan. 28, 2010

(54) APPARATUS FOR THE PREPARATION OF COFFEE-BASED BEVERAGES FROM PRE-PACKAGED PODS OR CAPSULES

(75) Inventors: Ettore VILLA, Binasco (IT); Giuseppe MATURO, Binasco (IT)

Correspondence Address: NIXON & VANDERHYE, PC, 901 NORTH GLEBE ROAD, 11TH FLOOR, ARLINGTON, VA, 22203, US

(73) Assignee: Gruppo Cimbali S.P.A., Binasco (IT)

(21) Appl. No.: 12/506,618

(22) Filed: Jul. 21, 2009

(30) Foreign Application Priority Data
Jul. 24, 2008 (EP) 08425499.4

(51) Int. Cl. A47J 31/44

(52) U.S. Cl. 99/288; 99/295

(57) ABSTRACT

An apparatus for supplying hot water to at least one brewing unit (1) operating with pre-packaged pods or capsules (23) containing one or more doses of ground coffee for the preparation of coffee-based beverages, the brewing unit being provided with a brewing chamber (22) and a discharge duct (36) from the brewing chamber for the supply of the prepared beverage, the apparatus comprising a water heat exchanger (4) with a first opening (5) for the introduction of cold water, a second opening (6) for the supply of heated water, a third opening (7) in the vicinity of the first opening (5), and a cold water supply pump (8) connected between a source (9) of cold water and the first opening (5) of the heat exchanger. The apparatus comprises a water distribution unit (3) provided internally with a chamber (14) stably connected to the second heated water supply opening (6) and to the third opening (7) of the heating member (4) disposed in the vicinity of the cold water inlet opening (5) by means of respective ducts (15. 16) creating a circulation of thermo-siphon type in the water, the chamber (14) being provided with at least one outlet (19) connected to the chamber (22) of the brewing device (1), which may be opened and closed, with the interposition of a valve (20) which may be controlled to open and close the outlet (19).

### TECHNICAL FIELD

The present invention relates to an apparatus for supplying hot water to a brewing device operating with pre-packaged pods or capsules containing one or more doses of ground coffee for the preparation of coffee-based beverages, the brewing device being provided with a chamber which can be opened and closed in which the pod or capsule is disposed and with a discharge duct from the chamber for the supply of the prepared beverage.

### BACKGROUND ART

An example of a coffee machine using a brewing device in which doses of ground coffee pre-packaged in pods or capsules are disposed is disclosed in WO 2002/058523.

Typically, the brewing devices are installed in apparatus provided with devices able to heat the brewing water and force it to pass through the pod or capsule to produce the finished beverage.

In order to make use, in the case of pod or capsule brewers as well, of the energy advantages resulting from the use of the steam boilers which are normally used in espresso coffee machines, often coffee machines also supply hot water for the preparation of infusions such as tea or camomile, and the steam for heating and possibly frothing milk, in addition to preparing coffee.

Patent application No. WO 98/047418 describes a method for transforming an espresso-coffee machine maker operating in vertical extraction either with a ground coffee filter, or with ground coffee packs such as pre-measured tablets, the tablets being used in a horizontal plane, into an espresso-coffee maker which operates in horizontal extraction with pre-measured tablets, the tablets being used in a vertical plane.

In coffee machines with ground coffee filters, it can be desirable to keep the dispensing device pre-heated and for that purpose circulatory systems of thermo-siphon type have been devised.

Patent application No. EP 1584273 discloses a device for the temperature control of a dispenser group that is applicable to a machine for preparing coffee with a boiler fitted with some means of heating for heating the water inside, at least one heater pipe in the form of a heat exchanger inside the said boiler, a cold water feed line coming from a water supply source at a preset pressure connected to the said heater pipe, a pipe connected at one of its ends to an outlet of the said heater pipe, and at the other end to an inlet of the same, with at least part of the said pipe extending through a body of a dispenser group to heat the same by means thermosiphon circulation by the hot water from the heater pipe, with tile said dispenser group body including an electro-valve that is connected so that it derives a flow of hot water from the pipe to at least one hot water outlet for the preparation of coffee.

Patent application No. EP 1074210 describes an espresso coffee machine comprising a dispensing device associated with a fluid circuit and means for heating the water contained in the said fluid circuit, wherein the machine comprises controllable means for regulating the flow in the said fluid circuit in order to allow the water to be conveyed to the said dispensing device at a given temperature.

With regard to coffee machines provided with a pod or capsule brewer, the Applicant has observed that such machines may suffer from the drawback that the brewing device is not able to supply coffee at the correct temperature after long pauses between one brewing operation and the next because of the resulting cooling and because it is difficult to make the pod or capsule brewer mounted on the boiler, from which it could obtain the required heating.

A further drawback lies in the fact that the pod or capsule brewer has to be located in the machine in a way which takes account the ergonomics of the operation to introduce the pod or capsule and the ease of removal of the spent pod or capsule, which also makes it necessary to provide and dispose a collection recipient on the machine.

The Applicant has observed that in a coffee machine for pre-packaged ground coffee, such as pods or capsules, provision of a circulation system of thermo-siphon type for keeping the temperature of both the distribution and the brewing device would significantly increase the complexity of the apparatus (e.g. by increasing the number of valves within the apparatus), also due the presence of moving parts that allow the opening and closing of the brewing chamber for housing the pre-packaged ground coffee.

### SUMMARY OF THE INVENTION

An object of the present invention is to provide an apparatus for supplying hot water to a brewing device operating with pre-packaged pods or capsules containing one or more doses of ground coffee for the preparation of coffee-based beverages in which the water maintains its temperature conditions even after long intervals of inactivity, thereby obviating the drawbacks discussed above.

The Applicant has understood that brewing devices for coffee preparation from pods or capsules can be realised with a relatively small thermal mass and, if hot water is supplied to the brewing chamber at a suitable temperature, e.g. selected within the range from 80° C. to 90° C., brewing can be carried out at a suitable brewing temperature, thereby ensuring the dispensing of a coffee with good quality.

It has been found that by providing an apparatus for preparation of coffee-based beverages from pre-packaged pods or capsules with a brewing unit and a separate distribution unit and by providing a thermo-siphon circulation system of water through the distribution unit, it is possible to maintain the water supplied to the brewing chamber of the brewing unit at a desired temperature while keeping complexity and costs of the coffee apparatus relatively low.

Advantageously, provision of a distribution unit and a separate brewing unit makes more straightforward to arrange the brewing unit within the coffee apparatus in a position such that the location of the one or more discharge spouts bear an ergonomic advantage.

Generally and according to an aspect, the present invention relates to an apparatus for the preparation of coffee-based beverages comprising: at least one brewing unit operating with pre-packaged pods or capsules containing one or more doses of ground coffee for the preparation of coffee-based beverages, said at least one brewing unit comprising a first and a second brewing chamber sections being movable relatively one to another so as to close and open a brewing chamber formed there-between and being apt to house a pod or a capsule, one of the chamber sections comprising a first inlet leading to the brewing chamber, said brewing unit further comprising a first discharge duct from the brewing chamber for supplying the prepared beverage, and a water heating device with a first opening for the introduction of cold water, a second opening for supplying heated water, the apparatus further comprising a water distribution unit spaced apart from the at least one brewing unit and being connected to the second opening of the water heating device through a hot water duct, wherein the water heating device is provided with a third opening being connected to a return duct, and wherein the water distribution unit is provided internally with a thermally regulated chamber connected to the hot water duct and to the return duct so as to create a water circulation of thermo-siphon type, wherein the thermally regulated chamber is provided with a first outlet in fluid communication with the brewing chamber and a first valve is provided in the water distribution unit for opening and closing the first outlet.

### BRIEF DESCRIPTION OF THE DRAWINGS

The invention will be described in detail below with reference to the embodiments thereof, given purely by way of non-limiting example, described in the following and illustrated in the accompanying drawings, in which:

FIG. 1 is a diagram of an apparatus according to an embodiment of the invention, in an inactive position with the pod brewer open and awaiting the introduction of a pod or capsule.

FIG. 2 is a diagram of the apparatus of FIG. 1 in the brewing position for a dose of coffee.

FIG. 3 is a diagram of an apparatus, in a closed brewing position, provided with two pod brewers, according to another embodiment of the present invention.

### DETAILED DESCRIPTION OF THE PREFERRED EMBODIMENTS

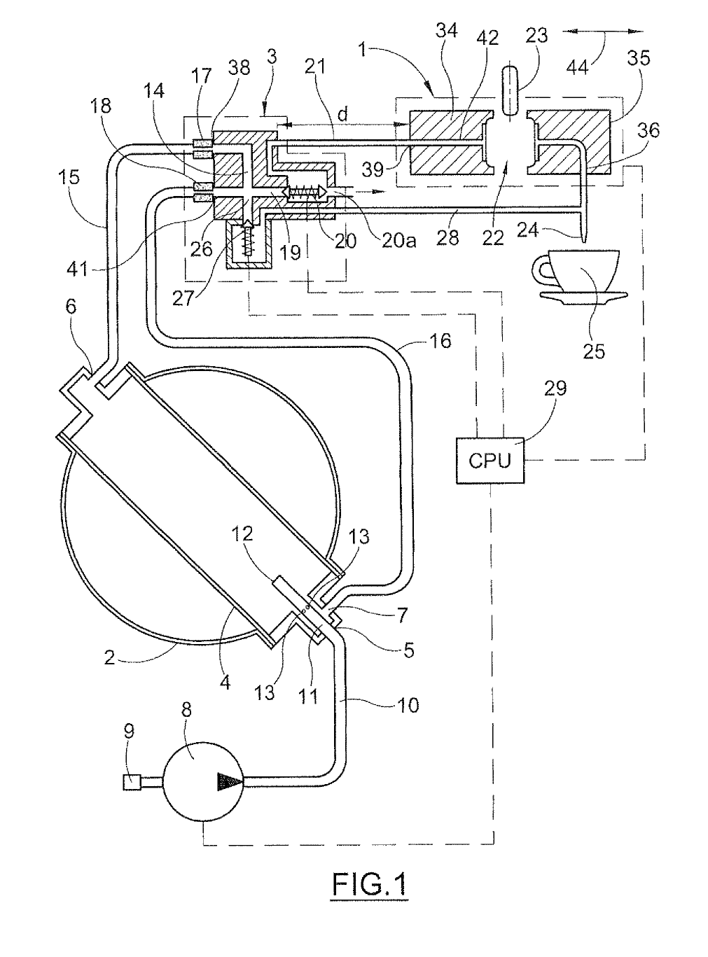

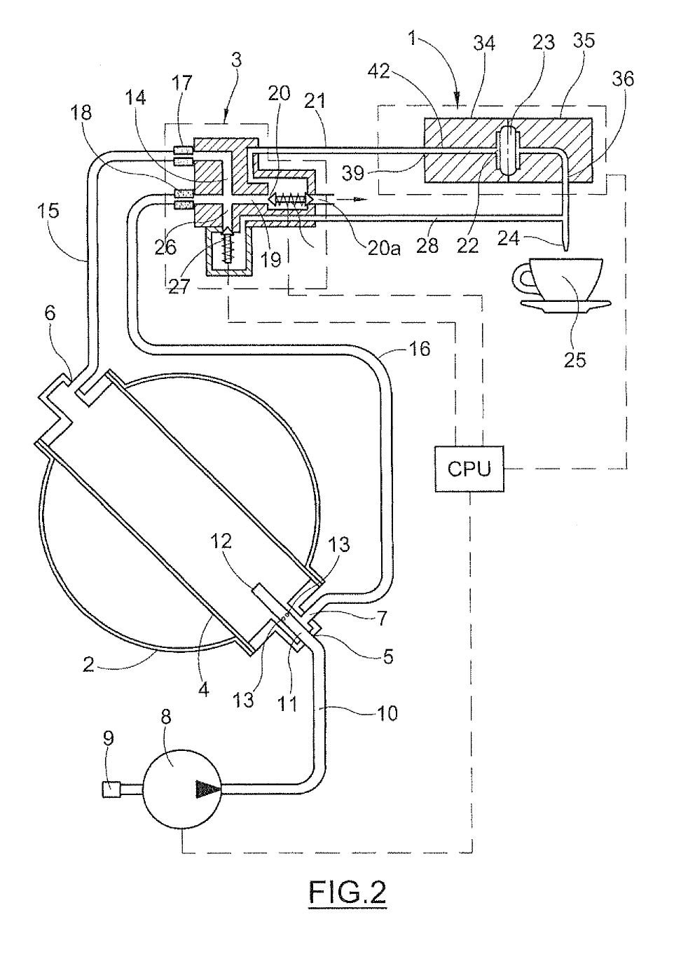

FIGS. 1 and 2 schematically illustrate a coffee apparatus comprising a pod (or capsule) brewing unit 1 being collectively indicated with a dashed line and a distribution unit 3, also indicated as a whole with a dashed line. The brewing unit 1 interfaces with a boiler 2 of the saturated steam type by means of the distribution unit 3. The structure of the pod brewing unit 1 can be of conventional type, such as of the type disclosed for instance in patent application No. EP 1146807. In particular, the brewing unit 1 comprises a first and second brewing chamber sections 34 and 35 being movable relative to one another, between an open position for receiving a pod 23 and a closed position for brewing the coffee contained in the pod. In the open position, the brewing chamber sections 34 and 35 are spaced apart and define a brewing chamber 22 there-between. The relative movement of the first and second sections 34 and 35 open and close the brewing chamber 22. In FIG. 1, the brewing chamber sections 34 and 35 are shown in the open position, whereas in FIG. 2 the sections are illustrated in the closed position. For example, second chamber section 35 can be moved back and forth along a direction substantially perpendicular to the direction of insertion of the pod between the sections, the direction of movement being indicated in FIG. 1 with double arrow 44. Mechanical movements of the sections can be achieved in a conventional manner and details are not shown in the figures.

The brewing unit 1 interfaces with a heat exchanger 4 which is disposed in the boiler 2 in a conventional manner and is provided with a first cold water inlet opening 5, a second hot water supply opening 6 and a third opening 7 in the vicinity of the first opening 5.

A cold water supply pump 8 is connected between a conventional water source 9 and the first opening 5 of the heat exchanger 4 by means of a cold water duct 10, whose portion 11, which is arranged within the heat exchanger 4, has an end opening 12 and comprises a plurality of transverse holes 13 opening into the heat exchanger in the vicinity of the third opening 7. The transverse holes 13, for example of diameter of approximately 1 mm, are provided to feed cold water into the heat exchanger 4 together with the opening 12 of the portion 11. For example, the plurality of holes 13 can be arranged circumferentially in a row around the portion 11 of the duct 10.

The distribution unit 3 internally comprises a thermally regulated chamber 14 which is stably connected with the heat exchanger 4 via a hot water duct 15 connecting the second hot water supply opening 6 with a first circulation inlet 38 provided in the distribution unit 3 and via a return duct 16 connecting a circulation outlet 41 to the third opening 7 of the heat exchanger 4. A water loop is then formed by the heat exchanger 4, the hot water duct 15 and the return duct 16. The loop allows water to circulate in and out the distribution unit 3 by the thermo-siphon effect.

In particular, a calibrated thermo-siphon circulation of the water from the heat exchanger 4 is established by means of the ducts 15 and 16 and the chamber 14 with the result that the distribution unit 3 and the members connected thereto are kept at the ideal and desired temperature even during pauses between one brewing operation and the next.

For example, the distribution unit 3 is kept warm by means of the circulation of water in the thermally regulated chamber 14 having a temperature of 84° C.

The brewing unit 1 is spaced apart from the distribution unit 3 by a given distance, d, and the two units are in fluid communication by means of a connection duct 21 that connects a first outlet 19 of the distribution unit to an inlet 39 of brewing chamber section 34. The distance d can for example range from 10 to 30 cm.

The distance between the distribution unit and the brewing unit may substantially correspond to the length of the connection duct or the length of the connection duct may exceed the distance between the two units. For example, the connection duct is a flexible tube which is bowed so that it curves along the distance between the two units.

In an embodiment, a gap exists between the distribution unit and the separate brewing unit and the brewing unit is thermally coupled to the distribution unit only through the connection duct that brings the hot water for the coffee preparation. This implies that the brewing unit and in particular the first and second brewing chamber sections, can be cooled down to a temperature that is significantly lower than the temperature of the distribution unit during operation of the coffee apparatus. Nevertheless, brewing of the coffee pods or capsules can take place at a suitable temperature thanks to the relatively high temperature of the water fed from the thermally regulated distribution unit through the connection duct.

The distribution unit 3 communicates by means of a valve 20 with the connection duct 21, which discharges into a brewing duct 42 comprised within the first brewing chamber section 34, the brewing duct 42 feeding the hot water of the connection duct to the brewing chamber 22 which, when open, as shown in FIG. 1, is ready to receive a pod or a capsule 23.

The second brewing chamber section 35 is provided with a discharge duct 36 leading to a discharge spout 24, the discharge duct 36 leaving the brewing chamber 22 for the supply of the beverage while it is being prepared and is directed towards a collection cup 25.

The hot water duct 15 and the return duct 16 are provided with respective section calibration members 17 and 18 which may in particular be of adjustable type.

These calibration members 17 and 18 make it possible to regulate the flows of water passing through the ducts 15 and 16 and thus to regulate the temperature of the water in the chamber 14 when a beverage is being prepared.

The distribution unit 3 is further provided with a second outlet 26 which is connected by means of a valve 27 to a dilution duct 28 which leads directly to the discharge spout 24 for the beverage being prepared. When this valve 27 is controlled to open the outlet 26, as shown in FIG. 1, hot water at the same temperature as the water in the chamber 14 may therefore he supplied directly to a cup 25 so that the beverage can be diluted with water at the same temperature as the water used to prepare the beverage.

The opening and closing of the valves 20 and 27 and the actuation of the pump 8 are controlled by a conventional control unit 29 of electronic type, in accordance with the program installed in the machine.

The opening and closing of the brewing chamber 22 of the brewing unit 1 may also be controlled by the same control unit 29.

The first brewing chamber section 34, and thus the brewing unit 1, receives the hot water from the distribution unit through the inlet 39 that is coupled to the connection duct 21. Preferably, the connection duct is made of flexible material, In some embodiments, the connection duct has a length of from 100 to 350 mm.

In order to reduce thermal dispersion along the connection duct, in some embodiments, the connection duct is made of a material with relatively low thermal conductivity. In an embodiment, the connection duct is a braided silicone tube, wherein multifilament yarns are co-extruded with a silicone elastomer to form a braid structure. The braiding enables the conduction duct to withstand a water pressure of 8-10 bar, necessary for coffee brewing.

For example, the connection duct has a circular cross section of 3 mm of internal diameter, 6 mm of external diameter, has a length of about 150 mm and a thermal conductivity of from 0.22 to 0.44 W/m-° C. Thermal dissipation of the hot water passing through such a connection duct was estimated to be of less than 1° C.

It is however to be understood that the present invention encompasses a connection duct made of other materials, such as copper or stainless steel.

The distribution and brewing units can be arranged within the coffee apparatus at different relative positions, for example at approximately the same height. It is emphasised that provision of two separate units improves a degree of freedom in the design of the apparatus. For example, the brewing unit can be arranged in such a way that positioning of the discharge spouts results ergonomically favourable.

With reference to FIG. 2, it can be seen that, after a pod or capsule 23 has been inserted in the chamber 22 of the brewing device 1, the closed chamber 22 is supplied with a dose of water at the required temperature by the distribution unit 3, under the action of the pump 8 and following the opening of the outlet 19 by the valve 20. The latter. when it keeps the first outlet 19 of the distribution unit 3 open, closes the respective discharge 20a which is normally open when the outlet 19 is being kept closed.

The discharge 20a makes it possible to discharge the residual pressure from the brewing chamber 22 when a beverage has been supplied.

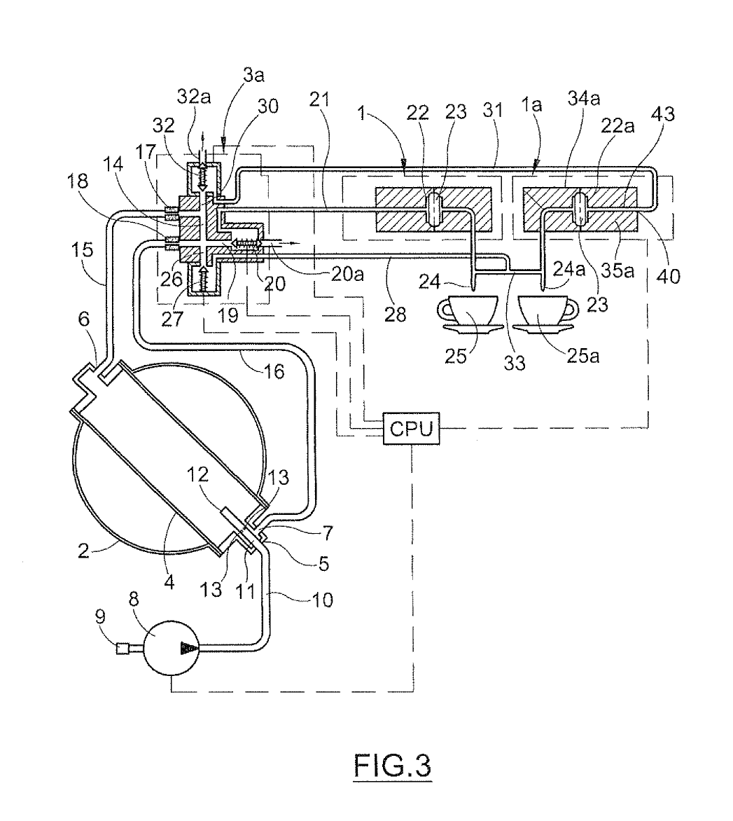

In the embodiment shown in FIG. 3, a distribution unit 3a is provided with a third outlet 30, which is brought into communication with a second connection duct 31 by means of a valve 32 with a relative discharge 32a.

The connection duct 31 can be equivalent to the connection duct 21 (e.g., made of the same material) of the embodiment of FIG. 1. For example, each connection duct 21 and 31 is a braided silicone tube. Connection duct 31 is adapted to supply the hot water to a second brewing unit la with a brewing chamber 22a which may be opened and closed and with a discharge duct 43 leading to a discharge spout 24a to a second cup 25a. The second brewing unit la comprises a first brewing chamber section 34a and a second brewing chamber 35a being movable relatively one to another. The second brewing unit la is in fluid communication with the distribution unit 3a by means of the second connection duct 31. which introduces the hot water in the second brewing unit T a through inlet 40.

In the embodiment shown in FIG. 3, the duct 28 from the second opening 26 of the distribution unit 3a is connected to a duct 33 connecting the discharge spouts 24 and 24a.

With the apparatus according to the invention as described above, the distribution unit 3a may be disposed in the coffee machine in the vicinity of the brewing devices 1 and 1a without detracting from their ease of use in terms of the insertion and removal of the pods and capsules and, at the same time, the water may be supplied to the brewing units 1 and 1a at the optimum temperature.

Moreover, with the apparatus according to the invention, it is possible to adapt the brewing temperature to the type of coffee desired. When the water circuit is in brewing mode, as shown in FIG. 2, the cold water supplied by the pump 8 to the exchanger 4 through the end opening 12 is partly discharged from the holes 13 and is mixed with the water of the region in the proximity of the third opening 7 of the heat exchanger.

This mixture, whose temperature depends on the transverse dimensions of the holes 13, is urged towards the thermally regulated chamber 14 of the distribution unit via the return duct 16 and the calibrated connection 18. A further flow of water reaches the chamber 14 from the hot water opening 6 of the heat exchanger 4 via the hot water duct 15 and the calibrator 17.

The two flows of water described above are mixed in the chamber 14 and it is the water from this mixing process which is supplied to the brewing chamber 22 or 22a when the outlet 19 or the outlet 30 or both are opened by means of the valves 20 and 32.

Moreover, by acting on the ratio between the sections of the calibrators 17 and 18 it is also possible to determine the brewing temperature depending on the type of coffee which it is wished to supply.

As a result, the device provides an extended possibility of regulating the temperature of the hot water.

For instance, for a coffee of Mediterranean type in small quantities the temperature of the water will be set to a higher value than that required for the preparation of a coffee with milk in longer quantities characteristic of the northern European regions.

It will be appreciated that the invention is not limited solely to the embodiments described above, but also includes other embodiments coming within the scope and spirit of the invention as claimed hereafter.

1. An apparatus for the preparation of coffee based beverages comprising:
at least one brewing unit operating with pre-packaged pods or capsules containing one or more doses of ground coffee for the preparation of coffee-based beverages, said at least one brewing unit comprising a first and a second brewing chamber sections being movable relatively one to another so as to close and open a brewing chamber formed there-between and being apt to house a pod or a capsule, one of the chamber sections comprising a first inlet leading to the brewing chamber, said to brewing unit further comprising a first discharge duct from the brewing chamber for supplying the prepared beverage, and
a water heating device with a first opening for the introduction of cold water, a second opening for supplying heated water,
the apparatus further comprising a water distribution unit spaced apart from the at least one brewing unit and being connected to the second opening of the water heating device through a hot water duct, wherein the water heating device is provided with a third opening being connected to a return duct, and wherein the water distribution unit is provided internally with a thermally regulated chamber connected to the hot water duct and to the return duct so as to create a water circulation of thermo-siphon type, wherein the thermally regulated chamber is provided with a first outlet in fluid communication with the brewing chamber and a first valve is provided in the water distribution unit for opening and closing the first outlet.

2. The apparatus according to claim 1, wherein the thermally regulated chamber is in fluid communication with the first outlet of the distribution unit through a connection duct.

3. The apparatus according to claim 1, wherein each of the hot water and return ducts connecting the thermally regulated chamber of the water distribution unit with the heating device is provided with a member for calibrating its cross-section.

4. The apparatus according to claim 3, wherein the calibration members may be adjusted.

5. The apparatus according to claim 3, wherein the calibration members provided on the respective hot water duct and return duct are mounted on the distribution unit.

6. The apparatus according to claim 1, wherein the thermally regulated chamber comprises a second outlet connected to the first discharge duct supplying the beverage from the at least one brewing unit with the interposition of a second valve for opening and closing the second outlet.

7. The apparatus according to claim 1, further comprising a second brewing unit including a second brewing chamber, wherein the thermally regulated chamber of the water distribution unit is provided with a third outlet connected to the second brewing chamber which may be opened and closed with the interposition of a third valve for opening and closing the third outlet.

8. The apparatus according to claim 7, wherein each of the first and third valves is provided with a respective discharge to atmosphere when it is positioned to close the respective outlet of the water distribution unit.

9. The apparatus according to claim 1, wherein a cold water duct comprises an end portion extending from the first opening for the introduction of cold water into the heating device, the cold water duct being connected to a cold water supply pump and the end portion being positioned within the water heating device in the vicinity of the third opening.

10. The apparatus according to claim 9, wherein the end portion within the water heating device comprises a plurality of transverse holes opening into the heating device.

11. The apparatus of claim 1, wherein the third opening is arranged in the vicinity of the first opening of the water heating device.
